(19) United States
(12) Patent Application Publication
(10) Pub. No.: US 2010/0233324 A1
(43) Pub. Date: Sep. 16, 2010

(54) METHOD OF PREPARING TRAY-BASED FOODS

(76) Inventor: Joe Fuda, Woodbridge (CA)

Correspondence Address: GOTTLIEB RACKMAN & REISMAN PC, 270 MADISON AVENUE, 8TH FLOOR, NEW YORK, NY, 10016-0601, US

(21) Appl. No.: 12/402,056

(22) Filed: Mar. 11, 2009

(51) Int. Cl. A21D 13/00; A23L 1/00

(52) U.S. Cl. 426/95; 426/292

(57) ABSTRACT

The present invention is directed to a distributed system and method for preparing tray-based foods and in particular, pizza pie, in which a pie together with its ingredients are prepared in stages, including intermediate freezing of at least a subset of ingredients. The present invention is characterized by methods of preparing and distributing at least a subset of those ingredients distinctly from other ingredients initially without use of the base layer.

### FIELD OF INVENTION

The present invention relates to a method of food preparation. More specifically, the invention involves the preparation of tray-based and/or layered foods. Even more particularly, the invention is directed to a method of preparing foods in which preparation is distributed across a plurality of locations and an amalgam of ingredients is formed and frozen for use with an edible base.

### BACKGROUND OF THE INVENTION

Restaurants traditionally aim to meet consumer demands for flavorful and safe foods, speedy service, and low cost. Notably, the attributes of speedy service and low cost are often at odds with providing good quality food that consumers enjoy eating. For example, pizzerias and Italian restaurants that are known for delicious pizza often take the time to prepare homemade pizza dough using their own recipe. After a pizza dough is prepared, the chef rolls the dough out on a tray and then pours pre-made sauce and places a selection of toppings on the surface of the dough. The uncooked pizza is then baked in an oven for a desired amount of time at a desired temperature. Although a tasty product may result from this process, this process, as a whole, is time consuming and often times lead to a patron becoming impatient, leaving the establishment and/or declining to return. This timeliness problem persists even when all of the needed ingredients are available in the restaurant, but is considerably amplified when there is an unexpected absence of needed ingredients or patrons collectively demand more pizzas faster than the establishment's ability to meet demand.

Similarly contributing to the strain on time is the fact that tray-based foods such as pizzas are customized per the specifications of a restaurant patron. Because pizzas with numerous combinations of ingredients may be ordered, custom-creating pizzas requires all possible toppings to be available and prepared for use. For example, peppers, broccoli, tomatoes, pepperoni and onions (and a host of others) must each be pre-sliced, plentiful, and sitting in bins awaiting use. The placement of toppings in a uniform and efficient manner adds more waiting time for customers, and in some instances the wait results in customers walking out and in loss of revenue to an establishment.

Ordinarily, restaurants maintain bins with each bin containing one of the various potential toppings. These bins generally are conveniently located near the area of the kitchen where the pizza is prepared. Restaurants have those bins handy so as to reduce preparation time. A pizza maker will reach into the appropriate bin (or use a utensil to reach in) to extract an amount of topping from a bin and will distribute the topping on the rolled out dough. Because of re-use of utensils or spillage, this process has the potential to result in cross-contamination of toppings. That is, at least some of one topping may inadvertently mix with other toppings. Such cross-contamination is problematic for people suffering from particular allergies and for people with other dietary restrictions. For example, people with shellfish allergies can be harmed by cross-contamination of an ordered topping by shrimp, even if they do not typically order pizza with shrimp.

A number of other issues also arise in the context of preparing a tray-based food such as pizza. For example, because a tray-based food like pizza is typically baked uniformly in an oven at a relevantly constant temperature, over a finite and often pre-determined period of time, in order to assure that certain ingredients (e.g., raw chicken or shrimp) are cooked long enough at a high enough temperature, those ingredients may have to be partially pre-cooked, or else other ingredients may be overcooked. To assure all ingredients are appropriately cooked, pizza establishments must have an adequate supply of pre-cooked ingredients on hand, and must further prepare such ingredients when on hand supplies diminish or risk not meeting customer demand for pizzas with those ingredients. When the restaurant opts to pre-cook additional ingredients “on the fly,” resources, including human resources, must be allocated, thereby increasing overall cost and potentially increasing time to serve. The need for restaurants to prepare and partially cook ingredients “on the fly” is a significant drawback to the present method of restaurant preparation of pizza relative to the patron's expectation of time to serve and overall cost.

Moreover, in traditional preparation of tray-based foods such as pizza, increasing the speed at which toppings are placed on the dough generally decreases the consistency and uniformity of how those ingredients are placed. As a result, in the context of a pizza pie, when the pie is cut into sections, some pieces unintentionally have more of one ingredient and less of another. Generally speaking, customers prefer a uniform distribution so that each slice of a pizza is similar in form and content to every other slice.

Alternatively, some tray-based foods are fully prepared in advance and frozen in full. For example, a consumer can purchase a variety of frozen pizzas at supermarkets and convenience stores. However, these foods have a variety of drawbacks. First, because the dough is rolled out and then frozen, the frozen pizza tends to have a less appealing taste as compared to a pizza with fresh dough. Also, restaurants pride themselves on the dough they use and patrons select restaurants at least in part based on the dough. Retail establishments often distinguish themselves from their competition by the dough they prepare and use, and different establishments prepare dough in different ways using a variety of ingredients. This feature is wholly lacking in frozen pizza. Also, the lack of any meaningful preparation by a restaurant negates the overall restaurant experience—consumers may feel that they need not pay for a restaurant pizza when they could prepare the same frozen pizza at home.

In pizza which are prepared inclusive of the dough base and then frozen, the cheese on these pizzas is typically grated and spread or sprinkled on top prior to freezing. During packaging, handling, or unpackaging, some cheese may fall from the frozen pizza. The result may be a dissatisfied customer or the need to oversupply cheese.

### SUMMARY OF THE INVENTION

In view of the deficiencies and drawbacks in the prior art, it is a primary object of the present invention to provide an improved method of preparing tray-based foods, such as a pizza pie, that speeds on-site preparation time while maintaining a pizza's flavor, thereby promoting efficiency and customer retention for restaurant establishments.

Another object of the present invention is to provide a method of distributed preparation of tray-based foods, such as a pizza pie, that provides cost savings to restaurants and other retail establishments.

Yet another object of the present invention is to provide a method of preparing tray-based foods, such as a pizza pie, which can be served to a patron in a shorter period of time from when the food is ordered, as compared with conventional processes.

Still another object of the present invention is to provide a method of preparing tray-based foods, such as a pizza pie, which promotes consistency and uniformity.

Still another object of the invention is to provide an improved process for preparing a pizza in which a pizza is comprised only of a select set of toppings, without cross-contamination with unselected foods, so as to assure that customers with allergies to unselected toppings or other dietary restrictions are not negatively impacted.

Still another object of the invention is to provide an improved process for distributing cheese or other grated ingredients on a pie such that they are retained on the pie during freezing.

Additional objectives will be apparent from the description of the invention that follows.

In summary, the present invention relates to a method of preparing a tray-based food, such as a pie, and even more specifically, a pizza pie. The method of the present invention involves preparing a tray-based food in which the preparation is distributed across a plurality of locations and incorporates intermediate freezing.

The present invention overcomes the limitations of prior art methods of food preparation by providing a method of preparing an evenly distributed and uniform amalgam or collection of ingredients (including ingredients that require advance cooking or other forms of preparation). The amalgam is frozen into a single topping shaped to fit on a food base, and packaging the collection of ingredients for distribution for use in connection with a tray-based food. Once the amalgam is made available to a restaurant, the amalgam may be unpackaged, placed directly on a rolled-out dough or other base and the food is then placed in an oven for immediate cooking.

The present invention provides numerous benefits over the state of the art in terms of time, cost, and protection from cross-contamination. In the present invention, much of the pizza preparation is completed before the patron even orders a custom pizza, so the time between order and delivery to the patron is greatly reduced from traditional tray-based food and pizza preparation methods. Also, because the advanced preparation may be done more uniformly, more consistently, closer to the source of the ingredients, and more efficiently, the costs are reduced from those of traditional methods.

In addition, because ingredients are prepared and immediately frozen in place the need for preservatives is reduced.

In the present invention, the cheese may be incorporated into the sauce, thereby reducing the likelihood of cheese slipping from the frozen surface, thereby improving customer satisfaction.

This pre-preparation also provides the opportunity to better avoid cross-contamination and consumer safety in two ways. First, because the topping is prepared in advance and without the need for immediate response to a customer order, additional care can be taken to avoid inadvertent cross-contamination. Also, once a topping is prepared and the combined topping is wrapped for shipment, cross-contamination at a restaurant is eliminated.

Also, by freezing the amalgam, inclusive of all ingredients, the preparation process can be geographically distributed so as to take advantage of disparities in available work force.

Moreover, because the ingredients can be easily distributed uniformly, the time between order and delivery is reduced, overall costs resulting from labor and waste are reduced, and customer satisfaction can be improved greatly.

In summary, there is provided in a preferred embodiment of the present invention an improved method of preparing a tray-based food that reduces preparation time and promotes efficiency and consistency.

Generally, the method comprises the following steps:

a. cutting toppings at a first location;

b. preparing a sauce;

c. pouring and distributing the sauce on a cellophane-covered tray;

d. preparing toppings by pre-cooking certain ingredients, such as fish or chicken, as necessary so as to result in a common cooking time for the entire tray-based dish;

e. uniformly placing toppings on the sauce and tray; and

f. freezing said toppings and preparing the amalgam of toppings for shipping to a second location, such as a pizzeria or other retailer for further use with a dough base.

It should be understood that one or more steps may be added to those listed above, and that any one or more of the particular steps above may be removed or substituted by one or more other steps when appropriate, while still keeping within the spirit and scope of the present invention.

### BRIEF DESCRIPTION OF THE DRAWINGS

For a fuller understanding of the invention, reference is made to the following description taken in connection with the accompanying drawings, in which:

FIG. 1 is a flow chart of processes performed in connection with the preparation of ingredients prior to distribution of the ingredients and formation of an amalgam;

FIG. 2 is a flow chart of processes performed in connection with the formation of an amalgam of the prepared ingredients;

FIG. 3 is a perspective view of the materials used in the initial stages of preparing the frozen topping;

FIG. 4 shows a perspective view of the scale used for weighing with sauce on a tray;

FIG. 5 shows an elevational view of the tray and separator of the present invention; and

FIG. 6 shows a photograph of the completed and packaged frozen topping.

### DETAILED DESCRIPTION OF THE INVENTION

Generally speaking, a method and system for preparing tray-based foods is provided in which an amalgam of ingredients for tray-based foods is prepared in stages, including initially preparing sauce and toppings together, and freezing the combined toppings into a frozen layer formed to rest on an edible surface of predetermined size. The frozen layer may be shipped to a retail establishment to be placed on a rolled-out dough for final baking. In addition, the present invention may be applied to various other pies, both dough and non-dough based, including fruit pies and pasta. Also, the present invention may be applied to preparing foods with a covering, such as pot pies or fruit pies.

The invention should be construed broadly, but for the sake of clarity, we will be referring to the tray-based food, including a pie, as a pizza. Similarly, for simplicity, the use of the words “cutting” and “slicing” should be construed broadly to include dicing, julienning, grating, and other forms of preparing vegetables, fruit, proteins, or other ingredients for inclusion in the topping of a pizza.

In general, a pizza is comprised of a dough base with a variety of toppings upon the dough. The variety of toppings may vary from pizza to pizza but fundamentally includes a sauce and one or more cheeses. Additional toppings may include chopped, sliced, or whole vegetables or fruit and may also include protein based products, such as but not limited to shrimp, chicken, tofu, pepperoni, ham, bacon, or hamburger.

Consumers often prefer custom-made pizza using fresh dough and retailers take pride in their homemade dough. Dough can be a differentiator among pizza establishments. The present invention facilitates pizza preparation by using only fresh ingredients uniformly prepared as an amalgam and subsequently distributed for placing on a custom-prepared fresh dough.

The present invention also affords the opportunity to avoid cross-contamination between wanted and unwanted ingredients. Such cross-contamination can readily occur in traditional preparation processes and can cause harm to people with allergic reactions to certain foods or who have other dietary restrictions.

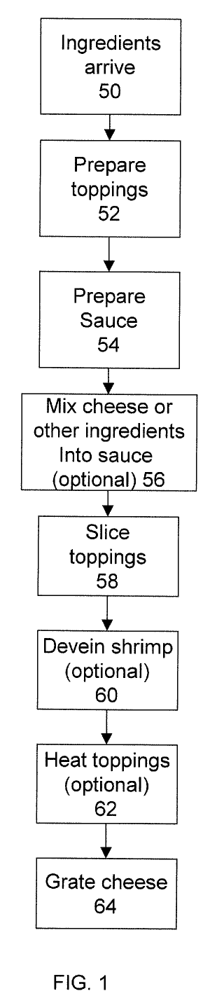

FIG. 1 shows the process steps in preparing an aggregated frozen topping or amalgam. The process begins with the arrival of fresh ingredients 50. These fresh ingredients arrive at the preparation site and are inspected to assure they are appropriate for use in the present preparation. Preferably, all ingredients are kept apart from each other to avoid cross-contamination.

The process continues by preparing the toppings 52. A sauce is prepared 54 by mixing ingredients, such as fresh tomatoes, together with additional ingredients which may vary based on taste. Generally, the sauce is prepared in the traditional method; that is, the ingredients are heated to form a sauce 56. In some instances, cheese and other ingredients may be mixed into the sauce. For example, one sauce that could be prepared would be a creamy parmesan cheese sauce with or without vannamai shrimp.

Some solid toppings, such as but not limited to olives, peppers, onions, mushrooms, fresh tomatoes, chives, and pepperoni, may be sliced 58. Still other toppings, such as shrimp, may additionally be prepared by deveining 60. However, to avoid cross-contamination, which could lead to an allergic reactions by some consumers, each of these items is preferably prepared (such as by cutting) apart from each other, kept separated, and prepared at different positions using different utensils. Other toppings, such as chicken, tofu, hamburger, ham, pepperoni, or shrimp may be sliced or chopped and also may be partially cooked in some way, such as by grilling or baking 62. Cheese may separately be prepared by grating or slicing 64.

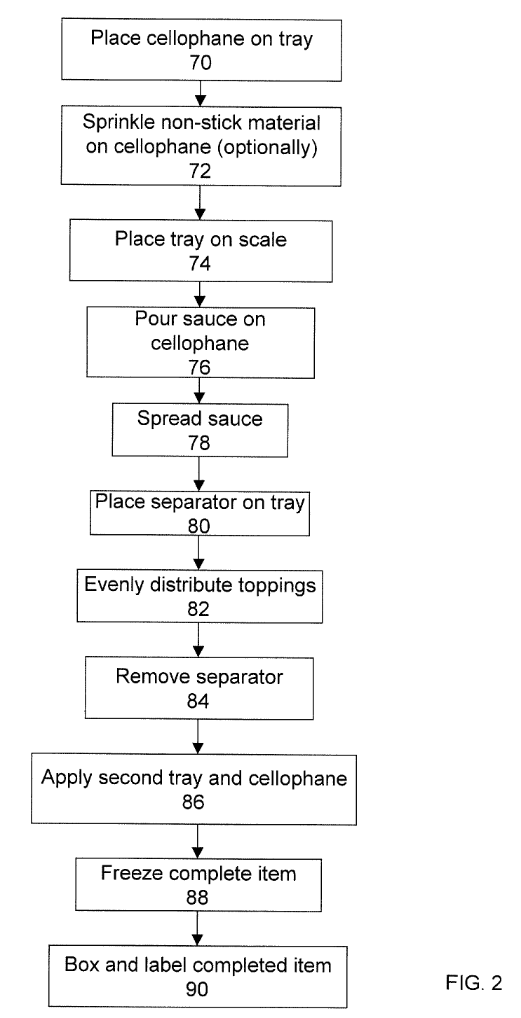

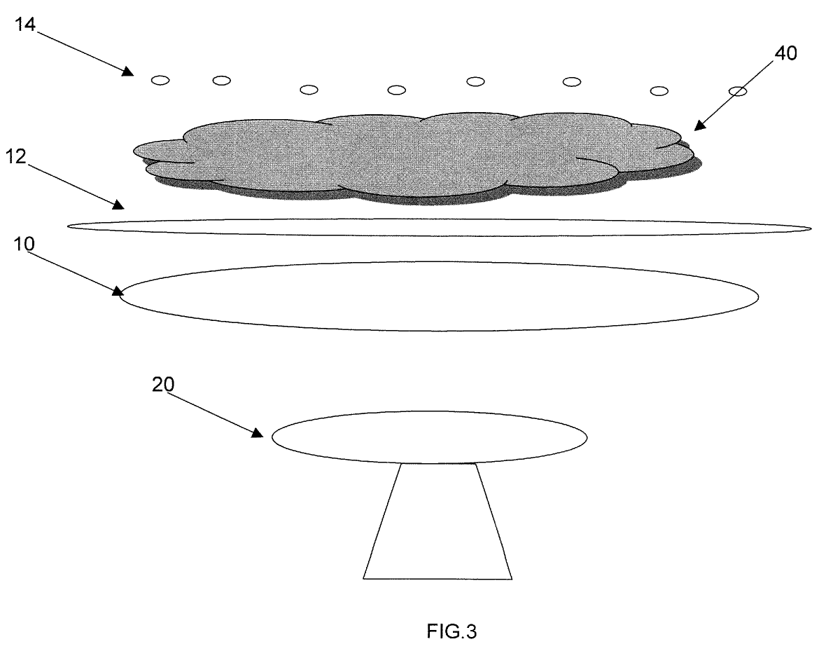

As each of the various ingredients is individually prepared, each can be used in the topping preparation process. The process is shown in FIG. 2 and the steps identified refer to that figure. FIG. 3 shows the different layers of material used in connection with the present invention, including tray 10, cellophane 12, sauce 40, and toppings 14. Tray 10 preferably is circular and may be of a variety of diameters or alternatively may be rectangular, with size based upon the ultimate diameter of the rolled out dough. Typically, the tray is of eight, ten, twelve, or fourteen inch diameter. The tray is preferably made of aluminum but other similarly light weight or solid materials may alternatively be used.

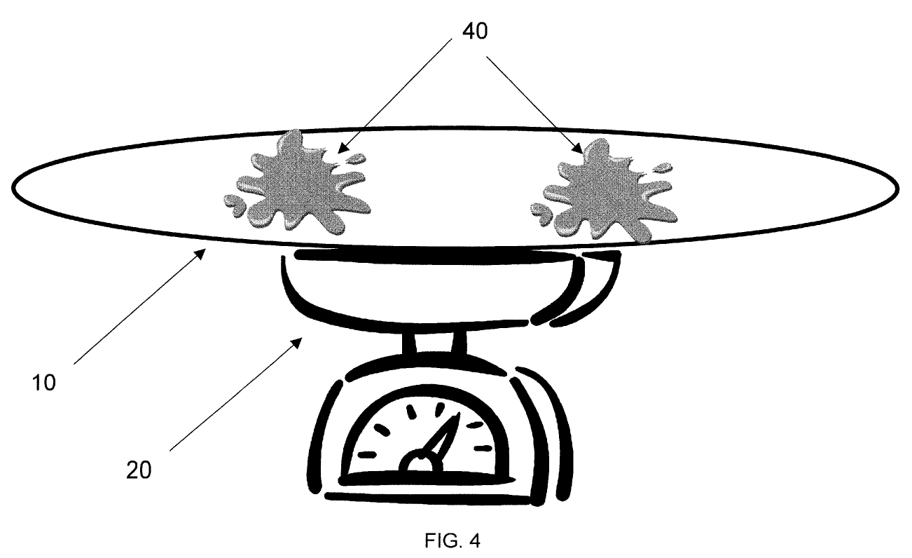

A tray 10 or other designated device and cellophane 12 are utilized in connection with the preparation of the amalgam. Cellophane 12 is placed 70 over tray 10. Tray 10 is sized similarly to the rolled out dough which will later be used with the amalgam. Optionally, a material to prevent sticking, such as olive oil, may be sprinkled 72 onto the upper side of cellophane 12. As can be seen in FIG. 3, tray 10 with cellophane 12 and any non-stick material is placed 74 upon a scale 20. Based upon the particular pizza, a pre-determined type and weight of sauce 40 is poured 76 onto the cellophane. FIG. 4 shows the sauce placed on tray 10 on scale 20.

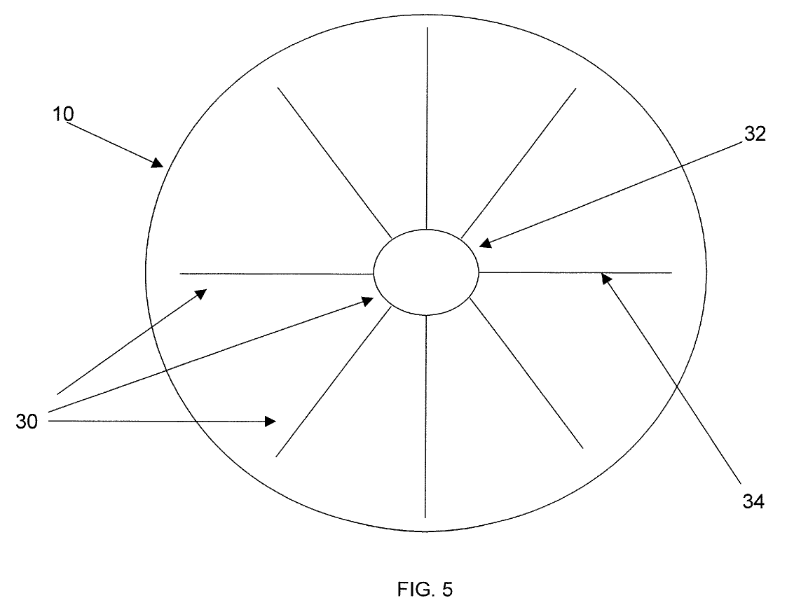

Often, a fully frozen pizza may include grated cheese, but the cheese generally is not mixed into the sauce. Once frozen over the sauce, the cheese often easily separates from the sauce and falls off. To overcome this problem, in the present invention, the sauce may be inclusive of cheese, depending upon the pizza being formed. Once the appropriate amount of sauce 40 is placed upon the cellophane, a preparer spreads the sauce 78 so that it is evenly distributed. At this point, separator 30 is positioned 80 over tray 10, inclusive of cellophane 12 and sauce 40. As can be seen in FIG. 5, separator 30 is comprised of central section 32 and a plurality of wings 34 and is formed of a hard plastic. Separator 30 divides the combined tray 10, cellophane 12, and sauce 40 into distinct compartments, whereby each compartment corresponds to a slice of pie. For example, if the pie is intended to have eight slices, separator 30 would have 8 sections divided by eight wings 34, extending from central section 32.

Separator 30 provides a means for a preparer to uniformly distribute solid toppings upon sauce 40. These toppings could include combinations of cheeses, vegetables, proteins (as defined above), and even fruit. Each additional topping is then distributed uniformly 82 in the various sections. In the preferred embodiment, each of these additional toppings is custom prepared. For example, if green peppers are including in the toppings, each of the eight sections might have four slices of green pepper. In the preferred approach, the toppings are pre-weighted or pre-distributed to conform with the number of sections. Alternatively, if a pie is intended to be half pepper and half onion, separator 30 can be used to assure a separation of ingredients. Once the toppings are placed on the pie, separator 30 is removed 84.

Also, to assure no cross-contamination during preparation, each ingredient is handled separately (such as distributed using different gloves for different toppings). Because the pizza is not to be served to a patron immediately, the preparers have time during the preparation process to assure each topping stays safely and completely apart from every other topping.

Different pizzas might have different combinations of toppings. For example, one pizza may have sauce, cheese, sliced tomatoes, and onions, whereas another may have sauce, cheese, mushrooms, and green peppers. Typically ingredient are selected from a group including but not limited to shrimp, scallops, crab, lobster, clams, tomatoes, green and red peppers, onions, mushrooms, eggplant, beans, green and black olives, cooked chicken, feta cheese, mozzarella cheese, parmesan cheese, pineapple, banana, various berries. In another embodiment, the toppings may further be garnished, such as with chives.

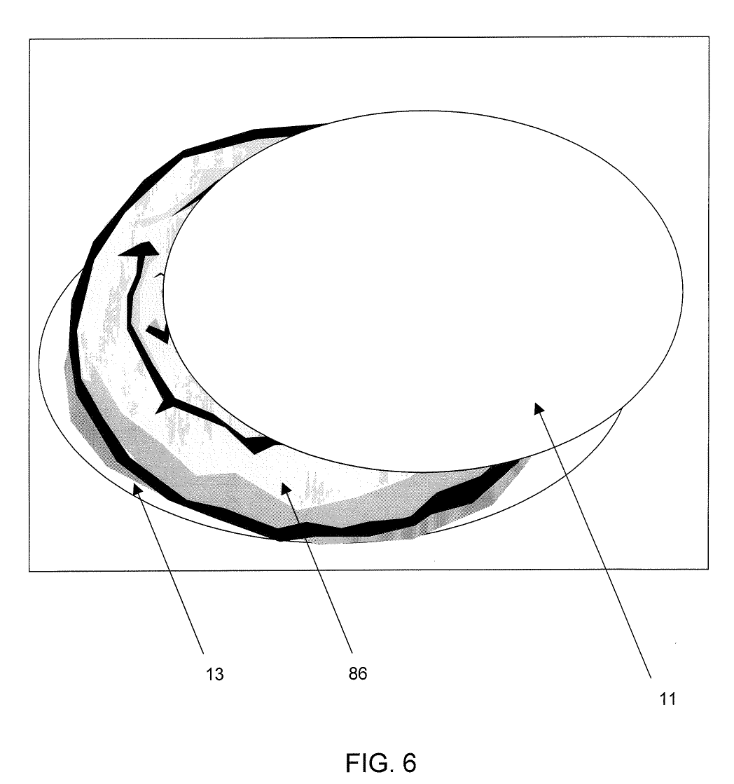

After all ingredients and any garnishes are distributed, and as can be seen in FIG. 6, the layer of toppings is further covered 86 by a second tray 11 and a second layer of cellophane 13. In the preferred embodiment, second tray 11 includes a plurality of openings as can be seen in FIG. 6. The completed item is then frozen. Nominally, freezing is at or below −18 Celsius (C.). Generally, the frozen ingredients can remain frozen safely for up to fourteen months. These completed items are then boxes and labeled 90 and shipped frozen to retail locations for completion. When shipped, the ingredients must remain frozen at or below −18 C.

To complete preparation of a pie, each individual retail location prepares the dough base for each pie. The dough base is typically a flour-based dough, but is customized by each retail location by inclusion of, for example, various spices or herbs.

At the retail location, the dough is laid out on a cooking tray. The wrappings from the amalgam are removed and the still frozen amalgam is placed on the dough for baking. The combined dough and amalgam may then be baked as needed at a predetermined temperature for a predetermined time and subsequently served to the consumer.

It will thus be seen that the objects set forth above, among those made apparent from the preceding description, are efficiently attained and, since certain changes may be made in carrying out the above process, in the described product, and in the construction set forth without departing from the spirit and scope of the invention, it is intended that all matter contained in the above description and shown in the accompanying drawings shall be interpreted as illustrated and not in a limiting sense.

It is also to be understood that the following claims are intended to cover all of the generic and specific features of the invention herein described, and all statements of the scope of the invention which, as a matter of language, might be said to fall therebetween.

1. A method for preparing ingredients for a pie comprising the steps of:
covering a tray of predetermined size and shape with cellophane;
placing a plurality of edible ingredients of multiple varieties on said cellophane; and
freezing said plurality of edible ingredients, said tray, and cellophane together, said edible ingredients thereby forming a frozen amalgam;
wherein said frozen amalgam is suitable for placement on a base of a pie which may subsequently baked; and
wherein each of the varieties of edible ingredients is separately stored and all of said varieties are kept separated from one another until said edible ingredients are placed on said cellophane.

2. The method of claim 1 wherein said pie is a pizza.

3. The method of claim 1 wherein said edible ingredients are selected from a group consisting of sauce, cheese, sliced or chopped vegetables, sliced or chopped meats, chicken, fish, or tofu, and sliced or chopped fruit.

4. The method of claim 3 wherein at least one of said edible ingredients is pre-cooked prior to placement on said cellophane so that said the remaining cooking time for said amalgam is approximately the same as the cooking time for the base.

5. The method of claim 1 wherein the result of said distributing edible ingredients results in a uniform distribution.

6. The method of claim 1 wherein said base is formed from pasta.

7. A method for preparing a frozen amalgam of ingredients for use with a pie having an edible base, comprising the steps of:
covering a tray with a section of cellophane;
pouring sauce on said cellophane;
placing cut toppings on said sauce; and
freezing said sauce and toppings into a formed amalgam,
wherein each of the variety of edible ingredients is separately stored and all of said varieties are kept separated from one another until placed on said amalgam.

8. The method of claim 7 wherein said pie is a pizza.

9. The method of claim 7 wherein said edible ingredients are selected from a group consisting of sauce, cheese, sliced or chopped vegetables, sliced or chopped meats, chicken, fish, or tofu, and sliced or chopped fruit.

10. The method of claim 9 wherein at least one of said edible ingredients is pre-cooked prior to placement on said cellophane so that said the remaining cooking time for said amalgam is approximately the same as the cooking time for the base.

11. A method for uniformly distributing toppings for a pie comprising the steps of:
cutting edible ingredients of different varieties into similarly sized pieces, each type of ingredient prepared separately from each other type of ingredient;
spreading a section of cellophane on a tray;
spreading sauce on said section of cellophane;
placing a separator having a plurality of wings that form a plurality of equally-sized sections upon said section of cellophane;
selecting after said cutting step a quantity of said ingredients of different varieties for placing on said sauce and cellophane;
placing an equal amount of said ingredients in said plurality of equally-sized sections;
removing said separator;
freezing said sauce and ingredients together into an amalgam which is suitable for placement on a base of a pie which may subsequently baked; and
wherein each of the varieties of ingredients is separately prepared and stored and all of said varieties are kept separated from one another until placed on said amalgam.

12. The method of claim 11 wherein said edible ingredients are selected from a group consisting of cheese, sliced or chopped vegetables, sliced or chopped meats, chicken, fish, or tofu, and sliced or chopped fruit.

13. A packaged preparation comprising:
a tray of predetermined size and shape;
cellophane sized and shaped to cover said tray;
edible sauce;
edible cut toppings;
wherein said tray, cellophane, sauce, and cut toppings may be frozen together, said sauce and said cut toppings thereby formed into an amalgam matingly shaped to said tray.
